(19) United States
(12) Patent Application Publication
(10) Pub. No.: US 2001/0042310 A1
(43) Pub. Date: Nov. 22, 2001

(54) Flush cut power saw apparatus

(76) Inventor: Roland Steele, Annandale, VA (US)

Correspondence Address: Rodger Flagg, Patent Agent, 2121 Eisenhower Ave, Suite 500, Alexandria, VA, 22314, US

(21) Appl. No.: 09/846,360

(22) Filed: May 2, 2001

Related U.S. Application Data
(60) Provisional application No. 60/201,293, filed on May 2, 2000.

(51) Int. Cl. B27B 19/09

(52) U.S. Cl. 30/375; 30/166.3; 30/392

(57) ABSTRACT

The flush cut power saw comprises a framework having a base plate with a saw blade slot extending through two risers located at one end of the base plate. At least two rods slidably receive a movable housing for supporting a motor at a location above the cutting blade. The motor is secured to a transmission to convert the rotary motion of the motor to a reciprocating, linear motion. The transmission is connected to a saw blade mounting apparatus, which linearly reciprocates a cutting blade, which adjustably extends below the mounting plate. The cutting blade may be adjustably positioned with an adjustable stop for depth in vertical alignment with the framework. The transmission reciprocally biases the cutting blade, enabling the cutting blade to reciprocally travel linearly in relation with the movable housing, to complete a cut flush with an adjoining surface, while controlling the depth of cut. In this manner, both the depth of cut and the length of stroke may be adjusted to complete a cut flush in proximity to an external abutting surface adjacent to at least two vertical risers extending from the base plate.

This patent application relates to a power saw apparatus, and more specifically to a power saw apparatus adapted for finishing a saw cut where a circular saw or jig saw has been previously used, and the saw cut is required to extend to cut flush with an abutting surface, such as a wall, column or other vertical obstruction.

### BACKGROUND OF THE INVENTION

Custom carpentry often requires modifications to the floor, walls, ceiling, column or other obstruction of an existing structure. Circular saws and saber saws are in common use during custom carpentry. Circular saws do not cut flush with an adjacent wall or other abutting surface, as the radius of the saw limits the travel of the saw. Jig saws can only cut up to the distance between the blade and the end of the base plate of the saber saw. Thus, a hand saw is often required to finish the cut of a circular saw or a saber saw. This is time consuming, and inefficient, as many custom carpentry jobs are billed by the hour. Furthermore, some applications require a limit on the depth of the cut, which is difficult to accomplish with a hand saw or other existing hand powered tools.

U.S. Pat. No. 5,964,039 issuing to Soichiro Mizoguchi et al. on Oct. 12, 1999 discloses a cutting saw having a right angle drive gear which drives a cam which in turn vertically reciprocates a saw blade.

U.S. Pat. No. 5,033,684 issuing to Hans von der Heide on Jul. 23, 1991 discloses a silage cutting machine which is vertically movable on a mounting rack. Cutting blades are slidably mounted in relation to the frame.

U.S. Pat. No. 4,953,301 issuing to Howard Dobbs Jr. on Sep. 4, 1990 discloses a heavy duty reciprocating hand held power saw for use in the meat packing industry. No provision is disclosed to control the depth of cut or to position the reciprocating end of the saw blade flush with an external abutting surface.

U.S. Pat. No. 4,784,034 issuing to Kevin Stones et al. on Nov. 15, 1988 discloses an alternate transmission means for converting the rotating actuation of a motor to a linear reciprocating actuation of a saw blade.

U.S. Pat. No. 4,027,390 issuing to Leo Kendzior on Jun. 7, 1977 discloses a hydraulic motor for driving a eccentric cam to reciprocate a link and to rock a bell crank to drive a saw blade.

U.S. Pat. No. 3,901,117 discloses a saber saw using a lug to translate circular motion to linear reciprocating motion.

Thus, what is needed is a power saw capable of sawing flush with an adjacent wall, column, or other structure, wherein the depth of cut may also be selectively controlled.

### SUMMARY OF THE INVENTION

The flush cut power saw apparatus comprises a framework having a base plate with a saw blade slot extending through two risers located at one end of the base plate. At least two rods slidably receive a movable mounting plate. The movable mounting plate supports an adjustable motor mount. The motor is secured to an adjustable motor mount and operatively connected to a rotational-to-linear transmission means. The transmission means reciprocates a cutting blade, which extends below the movable mounting plate. The cutting blade may be adjustably positioned with an adjustable stop for depth in vertical alignment with the framework. The transmission means reciprocally biases the cutting blade, enabling the cutting blade to reciprocally travel linearly within the saw blade slot in the base plate, to complete a cut flush with an adjoining surface, while controlling the depth of cut. In this manner, both the depth of cut and the length of stroke may be adjusted to complete a cut flush with an external abutting surface adjacent to the vertical risers on the framework.

### BRIEF DESCRIPTION OF THE DRAWINGS

FIG. 1 is a perspective view of the flush cut power saw, with the saw blade shown retracted above the base of the framework in solid line, and extending below the base of the framework in dashed line.

FIG. 2 is a schematic view of one example embodiment of the transmission means for converting the rotary motion of the motor to a linear reciprocating motion.

### DETAILED DESCRIPTION OF THE PREFERRED EMBODIMENT

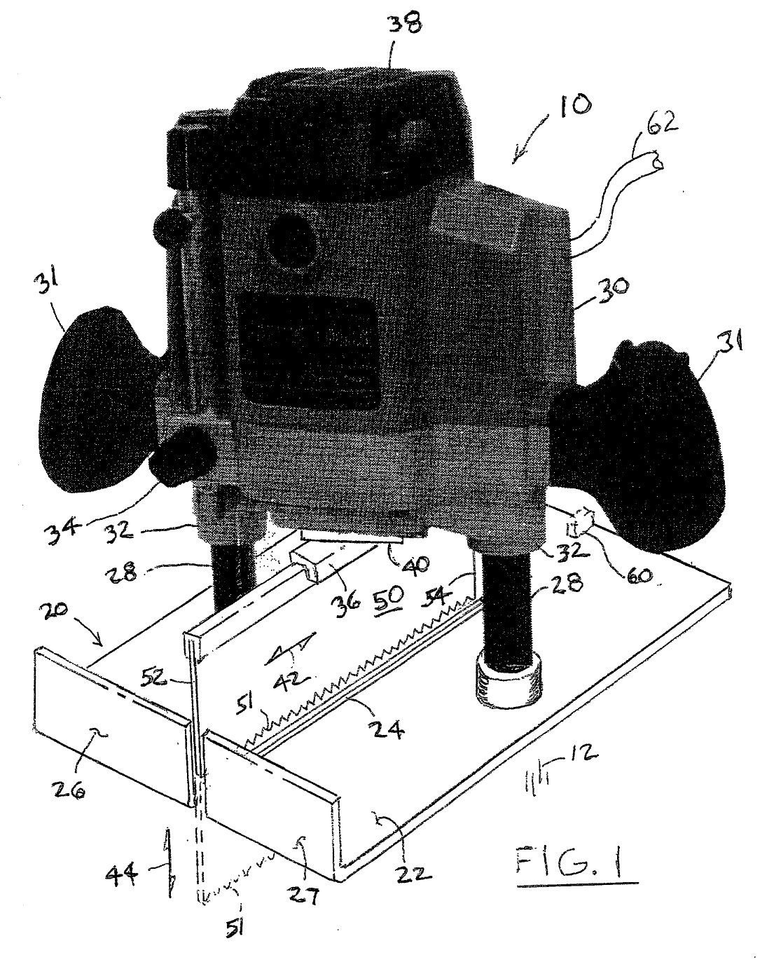

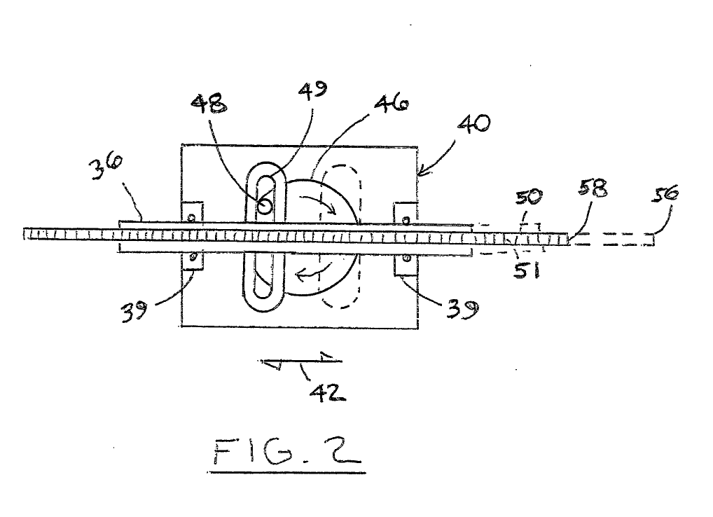

As best shown in FIG. 1 and FIG. 2, the flush cut power saw apparatus 10, comprises a framework 20 having a base plate 22, which rests on the surface to be cut 12. The base plate 22 has a saw blade slot 24 extending through a portion of the base plate 22. The saw blade slot 24 extends through vertical risers 26, 27 located at one end of the base plate 22. At least two vertically aligned rods 28 are secured to the base plate 22. The vertically aligned rods 28 slidably receive a movable housing 30 thereon. Preferably, the movable housing 30 is guided by a linear bushing or bearing 32 which is slidably received upon each of the vertically aligned rods 28. The operation and actuation of the movable housing 30 is similar to the well known actuation of a plunge router, and thus not further detailed herein. In this manner, the height of the movable housing 30 may be adjusted in relation to the base plate 22 to control the depth of cut.

An adjustable stop 34 is adjustably secured to at least one vertical rod 28 to limit travel of the movable housing 30 in relation to the framework 20 to a pre-selected depth. An internal spring (not shown) may be mounted between the movable housing 30 and one or more of the vertical rod(s) 28, to raise the movable housing 30 to a height sufficient to raise the saw blade 50 above the saw blade slot 24 in the base plate 22.

Downward pressure on one or more handles 31 secured to the movable housing 30 lowers the saw blade 50 through the saw blade slot 24 in the base plate 22 to engage and cut the surface to be cut 12. Preferably the handles 31 are mounted on the movable housing 30, as shown in FIG. 1, for ease of applying downward pressure on the movable housing 30. Alternately, the handles 31 may be secured directly to the motor 38, without departing from the scope of this disclosure.

A motor 38 and a reciprocating transmission means 40 are securely mounted to the movable housing 30 and may be adjustably positioned in relation to the movable housing 30 by any known adjustment means. In one such embodiment, the motor 38 turns a rotatable member 46, which in turn rotates a pin 48. The pin 48 is slidably received within a reciprocating slot 49, which coverts rotary motion to reciprocating motion 42, in a manner well known in the art. The reciprocating slot 49 is preferably slidably received in bearings 39 to linearly, reciprocally bias a saw blade mounting apparatus 36. The saw blade mounting apparatus 36 releasably positions and secures the saw blade 50, in relation to the saw blade slot 24. Any known releasable mounting apparatus 36 may be used, without departing from the scope of this disclosure, or from the following claims.

Alternately, a cam member 45 may be used in place of the reciprocating slot 49, in a manner well known in the art, to reciprocally bias the saw blade mounting apparatus 36. Lever arms and gears may also be used to convert the rotating motion of the motor 38 to the reciprocating, linear motion of the saw blade 50. These means to convert rotating motion to reciprocating motion are not further detailed herein, as they are well known to one of average skill in this art.

The transmission means 40 converts rotating motion to reciprocating, linear motion, so that when the motor 38 rotates, the saw blade 50 is reciprocally biased back and forth in the saw blade mounting slot 24, in a manner well known in the art. Other known transmission means 40 may also be used, without departing from this disclosure, or from the scope of the following claims.

The saw blade 50 is horizontally, slidably biased by the transmission means 40, in relation to the movable housing 30. This provides reciprocating actuation of the saw blade 50 between an extended position 56 flush with the vertical risers 26, 27 on the base plate 22, and a retracted position 58 which places the saw blade 50 well within the vertical risers 26, 27 extending from in the base plate 20.

Thus, the saw blade 50 is substantially horizontally reciprocated back and forth in the direction of arrow 42 within the saw blade slot 24 to cut the surface 12 located below the base portion 20. As the cut proceeds, the user's hand pressure is used on handles 31 to exert downward pressure on the saw blade 50. The user's hand pressure may be varied to suit the hardness of the material to be cut, and the type of saw blade 50 selected. In this manner, the saw cut proceeds into the surface 12 to be cut, as the saw blade 50 is substantially horizontally reciprocated back and forth 42 in the saw blade slot 24. The substantially vertical travel, shown by arrow 44 of the movable mounting plate 30 riding on the rods 28 may be limited by releasably securing an adjustable stop 34 located on at least one rod 28, in a manner often used by plunge routers.

The saw blade 50 has a plurality teeth 51, which are preferably shaped to cut in both directions as the saw blade 50 is substantially horizontally reciprocated linearly within the slot 24. The number of teeth per inch may vary to suit the type of material being cut. Alternately, the saw blade 50 may be adapted to raise slightly as the saw blade 50 is reciprocated in one direction, and to lower slightly as the saw blade 50 is reciprocated in the opposite direction. In this way, the saw cut progressively cuts in one direction only. Of course, the saw blade 50 may also be adapted to selectively raise and lower at the back end and/or the front end as the saw blade 50 is reciprocated back and forth 42 by the motor 30 and associated transmission means 40.

The transmission means 40 converts the rotary motion of the motor 38 to the linear motion of the saw blade 50, in a manner well known in the art. Any suitable transmission means 40 known in the art may be used, and the transmission means 40 shown in FIG. 2 is but one example embodiment thereof.

Preferably, the motor 38 is electrically powered from either a remote power source via an electrical cord 62, or powered by rechargeable batteries (not shown) in a manner well known in the art. The motor 38 may be rated from 3 amp to 15 amp, depending upon the intended use. The motor 38 may be either AC or DC powered, to suit user preference. Other known means of power may also be adapted for use, such as pneumatic power or hydraulic power. Still other forms of power found on other types of hand power tools may also be used.

By adjustably positioning transmission means 40 in relation to the movable housing 30, the saw blade 50 reciprocating stroke may be horizontally adjusted to extend the end of the saw blade 50 to the edge of the base plate 22 framework 20, ensuring a flush cut which abuts a wall, obstruction or other right angle surface 14. Longer or shorter saw blades 50 may also be used to adjust the length of the cut, to suit the needs of the user. Specific lengths of saw blades 50 may also be selected to cut square or rectangular holes where needed.

The saw blade 50 will preferably extend from two inches to eight inches in depth, and from three inches to twelve inches in length. When the movable housing 30 is raised, the saw blade 50 will extend above the base plate 22. When the movable housing 30 is lowered, the saw blade 50 may be selectively limited in depth of travel by the adjustable stop 34. The saw blade 50 may be preferably lowered to the depth of the saw blade 50 minus the thickness of the base plate 22 and the height of the saw blade mounting apparatus 36.

At least one alignment tab 60 may be adjustably lowered in alignment with the saw blade 50 to a position below the base portion 22 into an existing saw cut 16, to easily and accurately align the saw blade 50 on the flush cut saw apparatus 10 with an existing saw cut 16 previously made with a circular saw, saber saw, jig saw or hand saw.

The vertical risers 26, 27 on the base plate 22 serve to position the flush cut power saw apparatus 10 in relation to an external abutting surface 14, such as an existing wall, barrier or other obstacle. By adjusting the position of the transmission means 40 in relation to the movable housing 30, the extended travel 56 of the saw blade 50 may be selectively positioned in relation to the external end of the base plate 22 adjacent to the vertical risers 26, 27 to ensure a flush cut.

The adjustable stop 34 located on at least one rod 28 provides a selected depth of travel of the saw blade 50 into the surface to be cut 12. In this way, the floor boards in an existing building may be cut to a selected depth flush with the wall, without damage to the wall, or the danger of cutting existing electrical wiring (not shown) extending beneath the floor boards. Alternately, the existing floor boards may be cut to a selected depth, without cutting into an existing heating duct or structural member positioned directly beneath the existing floor boards.

The flush cut power saw apparatus 10 disclosed herein is easily aligned with an existing circular saw cut, saber saw cut, jig saw cut or hand saw cut 16, by inserting an alignment tab 60 positioned on the base plate 22 in alignment with the saw blade slot 24 into an existing saw cut (not shown). When not needed, the alignment tab 60 may be raised above the base plate 20.

Thus, while a preferred example embodiment of the flush cut power saw apparatus 10 has been disclosed in a manner enabling one of average skill in this art to make and use this invention, it will become apparent to those of ordinary skill in the art that many modifications thereof may be made within the scope of the invention, and such alternate embodiments are to be accorded the broadest interpretation of the claims so as to encompass all equivalent structures and devices.

### Flush Cut Power Saw Apparatus

10—flush cut power saw apparatus

12—surface to be cut

20—framework

22—base plate

24—saw blade slot

26, 27—vertical risers

28—column(s) or rod(s)

30—movable housing

31—handles

32—linear bushing or bearing

34—adjustable stop

36—saw blade mounting apparatus

38—motor

39—bearings

40—transmission means

42—reciprocating linear motion

44—vertical travel

46—rotatable member

48—offset pin

49—reciprocating slot

50—saw blade

51—teeth

52—first end

54—second end

56—extended travel of saw blade

58—retracted travel of saw blade

60—adjustable alignment tab

62—electrical cord

1. A flush cut power saw apparatus, which comprises:
a) a power means with a rotatable drive means. the power means adjustably positioned and releasably secured to at least two spaced columns, each column having a distal end, the rotatable drive means depending between said two spaced columns;
b) a base plate having a vertical riser at a first end and an adjustable alignment tab located in proximity to a second end; the base plate having an elongated slot extending through said vertical riser and a portion of said base plate in alignment with said adjustable alignment tab; the distal ends of the two spaced columns secured to the base plate on opposite sides of said elongated slot;
c) the rotatable drive means operatively connected to a rotational-to-linear transmission means having a rotatable input and a linear output;
d) the linear output of the rotational-to-linear transmission means operatively connected to a saw blade having cutting teeth located at a distal end of said saw blade, the linear output of the rotational-to-linear transmission means to reciprocally and linearly bias the cutting blade within the elongated slot; and
e) at least one handle to manually guide the flush cut power saw apparatus to guide the reciprocating saw blade to flush cut a first surface adjacent to an abutting surface.

2. The flush cut power saw apparatus of claim 1, wherein a linear bushing is slidably received upon each of the spaced columns, to aid in adjustably positioning the power means in relation to the spaced columns.

3. The flush cut power saw apparatus of claim 1, wherein an adjustable stop releasably secures the power means in relation to the spaced columns to adjustably position the depth of the saw blade in relation to the base plate.

4. The flush cut power saw apparatus of claim 4, wherein a biasing means is positioned about at least one of the spaced columns to raise the power means, which in turn raises the saw blade at least partially above the base plate when the adjustable stop is released, and downward pressure on the handle(s) lowers the blade to a cutting position below the base plate.

5. The flush cut power saw apparatus of claim 1, wherein the rotating-to-linear transmission means comprises rotating an offset pin which is guided within a reciprocating slot, to convert rotary motion to reciprocating motion.

6. The flush cut power saw apparatus of claim 1, wherein the rotating-to-linear transmission means comprises a rotating cam member which is guided within a reciprocating slot, to convert rotary motion to reciprocating motion.

7. The flush cut power saw apparatus of claim 1, wherein the saw blade is releasably secured in relation to the rotary-to-linear transmission means, to selectively secure, remove, or adjustably position the saw blade in relation to the vertical riser on the base plate.

8. The flush cut power saw apparatus of claim 1, wherein the saw blade teeth are shaped to cut in both directions.

9. The flush cut power saw apparatus of claim 1, wherein the saw blade is adapted to raise slightly as the saw blade is reciprocated in one direction, and the saw blade is further adapted to lower slightly as the saw blade is reciprocated in the opposite direction, enabling the saw blade to progressively cut in one direction only.

10. The flush cut power saw apparatus of claim 1, wherein the length of the saw blade is selected to adjust the length of the cut.

11. A flush cut power saw apparatus, which comprises:
a) a power means with a rotatable drive means, the power means adjustably positioned and releasably secured to two spaced columns, each column having a distal end, the rotatable drive means depending between said two spaced columns;
b) a base plate having a vertical riser at a first end and an adjustable alignment tab located in proximity to a second end; the base plate having an elongated slot extending through said vertical riser and a portion of said base plate in alignment with said adjustable alignment tab; the distal ends of the two spaced columns secured to the base plate on opposite sides of said elongated slot;
c) the rotatable drive means operatively connected to a rotational-to-linear transmission means having a rotatable input and a linear output;
d) the linear output of the rotational-to-linear transmission means operatively connected to a saw blade having cutting teeth located at a distal end of said saw blade, the linear output of the rotational-to-linear transmission means to reciprocally and linearly bias the cutting blade within the elongated slot;
e) a biasing means positioned about at least one of the spaced columns to raise the power means, which in turn raises the saw blade at least partially above the base plate when the adjustable stop is released, and downward pressure on the handle(s) lowers the blade to a cutting position below the base plate.
f) an adjustable stop to provide adjustment of the depth of cut and releasable securement of the cutting blade in relation to the base plate; and
g) at least one handle is secured to the power means to manually guide the flush cut power saw apparatus to guide the reciprocating saw blade to flush cut a first surface adjacent to an abutting surface.

12. The flush cut power saw apparatus of claim 1, wherein a linear bushing is slidably received upon each of the spaced columns, to aid in adjustably positioning the power means in relation to the spaced columns.

13. The flush cut power saw apparatus of claim 1, wherein the rotating-to-linear transmission means comprises rotating an offset pin which is guided within a reciprocating slot, to convert rotary motion to reciprocating motion.

14. The flush cut power saw apparatus of claim 1, wherein the rotating-to-linear transmission means comprises a rotating cam member which is guided within a reciprocating slot, to convert rotary motion to reciprocating motion.

15. The flush cut power saw apparatus of claim 1, wherein the saw blade is releasably secured in relation to the rotary-to-linear transmission means, to selectively secure, remove, or adjustably position the saw blade in relation to the vertical riser on the base plate.

16. The flush cut power saw apparatus of claim 1, wherein the saw blade teeth are shaped to cut in both directions.

17. The flush cut power saw apparatus of claim 1, wherein the saw blade is adapted to raise slightly as the saw blade is reciprocated in one direction, and the saw blade is further adapted to lower slightly as the saw blade is reciprocated in the opposite direction, enabling the saw blade to progressively cut in one direction only.

18. The flush cut power saw apparatus of claim 1, wherein the length of the saw blade is selected to adjust the length of the cut.

19. A flush cut power saw apparatus, which comprises:
a) a power means with a rotatable drive means, the power means adjustably positioned and releasably secured to two spaced columns, each column having a distal end, the rotatable drive means depending between said two spaced columns;
b) a base plate having a vertical riser at a first end and an adjustable alignment tab located in proximity to a second end; the base plate having an elongated slot extending through said vertical riser and a portion of said base plate in alignment with said adjustable alignment tab; the distal ends of the two spaced columns secured to the base plate on opposite sides of said elongated slot;
c) a linear bushing is slidably received upon each of the spaced columns, to aid in adjustably positioning the power means in relation to the spaced columns;
d) the rotatable drive means operatively connected to a rotational-to-linear transmission means having a rotatable input and a linear output;
e) the linear output of the rotational-to-linear transmission means operatively connected to a saw blade having cutting teeth located at a distal end of said saw blade, the linear output of the rotational-to-linear transmission means to reciprocally and linearly bias the cutting blade within the elongated slot; the saw blade releasably secured in relation to the rotary-to-linear transmission means, to selectively secure, remove, or adjustably position the saw blade in relation to the vertical riser on the base plate; the saw blade adapted to raise slightly as the saw blade is reciprocated in one direction, and further adapted to lower slightly as the saw blade is reciprocated in the opposite direction, enabling the saw blade to progressively cut in one direction only;
f) a biasing means positioned about at least one of the spaced columns to raise the power means, which in turn raises the saw blade at least partially above the base plate when the adjustable stop is released, and downward pressure on the handle(s) lowers the blade to a cutting position below the base plate.
g) an adjustable stop to provide adjustment of the depth of cut and releasable securement of the cutting blade in relation to the base plate; and
h) at least one handle is secured to the power means to manually guide the flush cut power saw apparatus to guide the reciprocating saw blade to flush cut a first surface adjacent to an abutting surface.

19. The flush cut power saw apparatus of claim 18, wherein the rotating-to-linear transmission means comprises rotating an offset pin which is guided within a reciprocating slot, to convert rotary motion to reciprocating motion.

20. The flush cut power saw apparatus of claim 1, wherein the length of the saw blade is selected to adjust the length of the cut.
